(19) United States
(12) Patent Application Publication
(10) Pub. No.: US 2004/0109554 A1
(43) Pub. Date: Jun. 10, 2004

(54) Voice/data distribution hardware and method

(76) Inventor: Timothy Chris Mitchell, Richmond, VA (US)

Correspondence Address: TIM MITCHELL, 7540 West Broad Street, Richmond, VA, 23294, US

(21) Appl. No.: 10/647,751

(22) Filed: Aug. 25, 2003

Related U.S. Application Data
(60) Provisional application No. 60/405,362, filed on Aug. 23, 2002.

(51) Int. Cl. H04L 12/28; H04L 12/56; H04M 11/00; H04M 3/00

(52) U.S. Cl. 379/250; 370/910; 379/100.12

(57) ABSTRACT

Method and hardware for multiple distributing business or residential telephone connections and multiple Ethernet data connections over a standard 4 twisted pair telephone cable system.

This application is based upon Provisional Application No. 60/405,362 filed on Aug. 23, 2002.

### BACKGROUND OF INVENTION

1. Field of Invention

Generally this invention relates to voice/data networking and specifically relates to using one 4 twisted pair wire to deliver of both telephone and data networking to each computer/telephone user location. This invention has applications in both business and residential installations.

2. Description of Related Art

Rapid growth in the use of the Internet in home and business, and Ethernet networking for simultaneous computer access to the Internet creates a need for affordable wiring to connect these computer and telephone devices. Today, most businesses and many homes desire the use of multiple computers all connected to the Internet simultaneously.

Currently the FCC of the United States requires that all new homes being built have phone/data communications cable that contains 4 twisted pair of conductors. Business telephone systems may be installed with cable that contains 4 twisted pair of conductors. When a cable is present at a phone station location it delivers up to 4 telephone lines in a residential setting or uses 2 of the pair for the business telephone station.

Today, most homeowners use 2 lines or less and business telephone systems only use 1 or 2 twisted pair at the telephone station. The current method used to deliver an Ethernet connection to these stations is to install an additional 4 twisted pair voice/data communications cable connected to a computers network card and then connected to an Ethernet router. For existing homes and businesses desiring to add Ethernet connections to locations where only one 4 twisted pair wire is located requires the addition of another 4 twisted pair wire. This is expensive and in some cases impossible.

Since an Ethernet connection requires only 2 twisted pair of wires most home telephone locations and business telephone station locations have 2 spare pair of voice/data wiring available to be used for an Ethernet connection.

It may be seen that providing an additional 4 twisted pair voice/data cable to all locations requiring the use of telephone and Ethernet is redundant and expensive. In addition, a user deciding to isolate 2 unused twisted pair of wiring from the existing telephone system is faced with the complicated task of identifying the unused pairs and then making complicated connections.

Therefore, a great need exists for an easy to install Ethernet/telephone connection using existing 4 twisted pair wiring and easy to install interfaces to the existing telephone wiring system.

### BRIEF SUMMARY OF INVENTION

The basic idea of this invention is to use 2 unused pair of wires in an existing voice/data home or business wiring system in conjunction with an Ethernet router and computer network card to deliver data connections to a computer. The system will use the modules (the invention) and existing technology and standards (RJ 45X jacks and 110 punch-down connections) to deliver in a simple straightforward method access to telephone lines, a data network and the Internet.

This invention consist of four distinct pieces of hardware:

1. The Voice/Data Station Module (described in FIG. 1)

2. The Home Voice/Data Distribution Module(described in FIG. 1)

3. The Business Voice/Data Distribution Module (described in FIG. 2)

4. The Wall Voice/Data Station Module (described in FIG. 3)

### BRIEF DESCRIPTION OF THE DRAWINGS

In these drawings and description like numbers refer to like parts throughout. All outlets will use the TIA T-568-A Standard or the TIA T-568-B Standard. For this discussion we will discuss the TIA T-568-B Standard. By switching wire pairs the same invention may be used with either standard.

FIG. 1 shows the combination of telephone lines and Ethernet on a 4 twisted pair wiring system to deliver 2 telephone lines and an Ethernet connection to a Voice data outlet for connection to a telephone and a computer 10/100 base T computer network card.

FIG. 2 shows the combination of a business telephone line from a PBX or Key System and Ethernet on a 4 twisted pair wiring system to deliver 1 business telephone extension and an Ethernet connection to a Voice data outlet for connection to a telephone and a computer 10/100 base T computer network card.

FIG. 3 shows the Wall Station Voice/Data Module to which the business telephone and computer are connected.

Each item number on the drawing corresponds with a like number and description below:

### DETAILED DESCRIPTION OF THE INVENTION

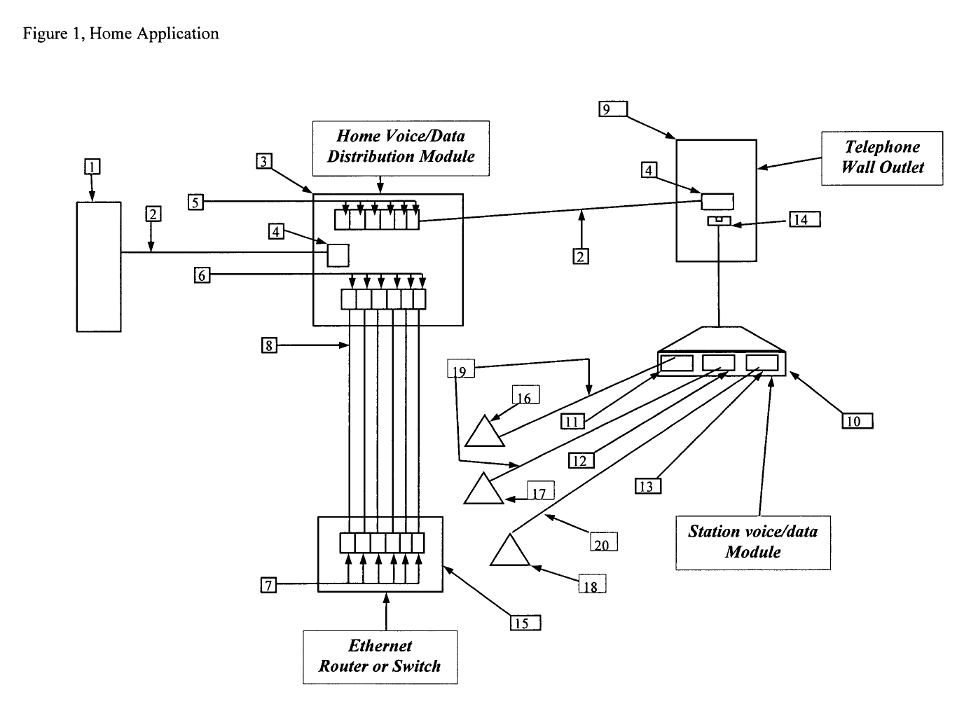

Description of FIG. 1 Home Voice/Data Distribution Module and Station Voice/Data Module Description of numbered items on FIG. 1

1. Phone Utility Interface

2. Four pair voice/data cable with colored wire pairs of White/Orange and Orange, White/Green and Green, White Blue and Blue, White Brown and Brown; used to connect telephone system with 110 punch-down on one end and RJ 45 male on the other end to

3. Home Distribution Module (number 1 of 4 parts of this invention) which combines telephone and Ethernet and delivers both to a station location and converts telephone line 2 (White/Orange, Orange pair) on pins 3 and 6 to the Brown/White, brown pair pins 7 and 8

4. Female RJ 45 jack which receives service from the telephone utility

5. Female RJ 45 jacks out to station pre-configured to deliver 2 telephone lines and Ethernet to a station location

6. Female RJ 45 jacks on face of the Home Distribution Module to bring Ethernet into the Home Distribution Module

7. RJ 45 connection out from an Ethernet Hub or Router

8. Ethernet patch cords

9. Telephone wall plate with female RJ-45

10. Station Voice/Data Module (number 2 of 4 parts of this invention) with 1 male RJ 45 jack to plug into the telephone wall outlet (#4) and 3 female RJ 45 jacks to connect to telephones and the computer network card.

11. RJ-45 (#11) jack brings the Blue/White and Blue wires to pins 4 and 5 and the Brown/White and Brown pair to pins 3 and 6 for delivery of 2 phone lines to a station from an RJ-45 female

12. RJ-45 (#1) jack brings the Brown/White and Brown pair to pins 4 and 5 for delivery of 1 phone line to a station from an RJ-45 female

13. RJ-45 female that brings an Ethernet connection on the Orange and Green pairs to pins 1, 2, 3, and 6 in the RJ-45 in the Station Voice/Data Module (number 2 of 4 parts of this invention

14. Mail RJ-45 which plugs into the female RJ-45 of the telephone wall plate

15. Ethernet Router or switch

16. 2 line telephone

17. single line telephone or fax machine receiving line 2

18. computer network card

19. telephone connector cables

20. data patch cord

This system of devices provides both voice and data distribution over one. 4 pair communications wire saving installation time and money. It will also allow homes wired for only telephone to implement a data network over the existing communications wiring system. Prior to this invention a complicated wiring scheme was used to provide both voice and data at the station or an addition 4-conductor wire needed to be run for access to the data network.

This system of wiring and devices makes it easier and less expensive than current methods of installing telephone and Ethernet at user locations wired with one 4 twisted pair wire. There is no need to pull an additional 4 twisted pair wire to each location requiring telephone and Ethernet reducing both time and expense to deliver these services.

It can now be seen that individuals with moderate skill in telecommunications can implement the system as described above and pictured in FIG. 1.

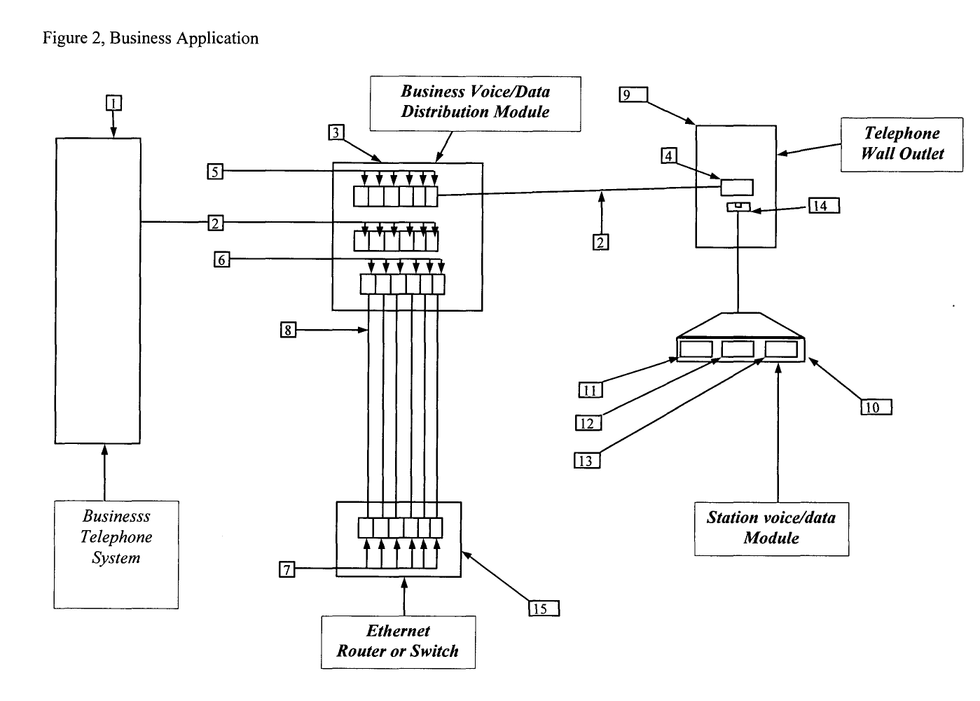

Description of FIG. 2 Business Voice/Data Distribution Module and Wall Station Voice/Data Module

Description of numbered items on FIG. 1

1. Phone Utility Interface

2. Four pair voice/data cable with colored wire pairs of White/Orange and Orange, White/Green and Green, White Blue and Blue, White Brown and Brown; used to connect telephone system with 110 punch-down on one end and RJ 45 male on the other end to

3. Business Voice/Data Distribution Module (number 3 of 4 parts of this invention) which combines telephone and Ethernet and delivers both to a station location and converts telephone station line from the White/Orange, Orange and the Blue White/Blue pairs on pins 3, 4, 5 and 6 to the Brown/White, brown Blue White/Blue pairs pair pins 4, 5, 7, 8

4. Female RJ 45 jack which receives service from the telephone utility

5. Female RJ 45 jacks out to station pre-configured to deliver business telephone station lines and Ethernet to station locations

6. Female RJ 45 jacks on face of the Business Voice/Data Distribution Module to bring Ethernet into the Business Voice/Data Distribution Module

7. RJ 45 connection out from an Ethernet Hub or Router

8. Ethernet patch cords

9. Telephone wall plate with female RJ-45

10. Station Voice/Data Module (number 4 of 4 parts of this invention) with 1 male RJ 45 jack to plug into the telephone wall outlet (#4) and 3 female RJ 45 jacks to connect to telephones and the computer network card.

11. RJ-45 (# 11) jack brings the Blue/White and Blue wires to pins 4 and 5 and the Brown/White and Brown pair to pins 3 and 6 for delivery of 2 phone lines to a station from an RJ-45 female

12. RJ-45 (#1) jack is not used in the business system configuration

13. RJ-45 female that brings an Ethernet connection on the Orange and Green pairs to pins 1, 2, 3, and 6 in the RJ-45 in the Station Voice/Data Module (number 2 of 4 parts of this invention

14. Mail RJ-45 which plugs into the female RJ-45 of the telephone wall plate

15. Ethernet Router or switch

This system of devices provides both voice and data distribution over one 4 pair communications wire saving installation time and money. It will also allow businesses wired for only telephone to implement a data network over the existing communications wiring system. Prior to this invention a complicated wiring scheme was used to provide both voice and data at the station or an addition 4-conductor wire needed to be run for access to the data network.

It can now be seen that individuals with moderate skill in telecommunications can implement the system as described above and pictured in FIG. 2.

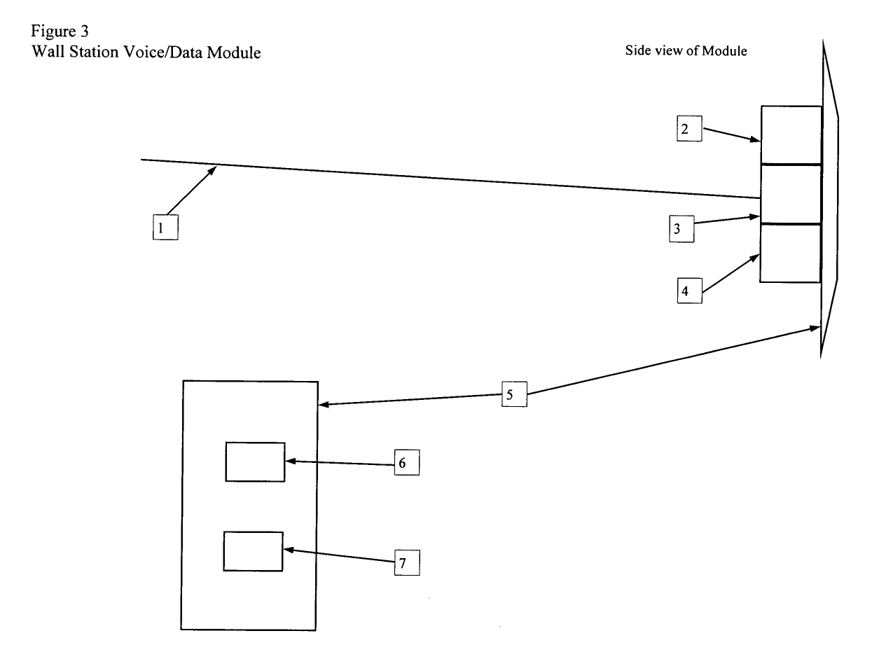

Description of FIG. 3 Wiring with the Wall Station Voice/Data Module

In this example the Wall Station Voice/Data Wall Plate is used in place of the Station Voice/Data Module

1. 4 pair Voice/data wire from either the Business Voice/Data Distribution Module or the Home Voice/Data Distribution Module

2. female RJ-45 which delivers business phone system extension to a station location on pins 3, 4, 5 and 6.

3. Female RJ-45 or 110 punch-down which receives business phone system service from a telephone system and Ethernet from a Home or Business Voice/Data Distribution Module.

4. female R-45 which delivers Ethernet to a computer station user

5. the Wall Station Voice/Data Module

6. front view of the female RJ-45 which delivers business phone system extension to a station location

7. front view of the female RJ-45 which delivers female R-45 delivers Ethernet to a computer station user

8. telephone extension cord which plugs into a business system telephone

9. computer patch cord which plugs into a computer network card

It can now be seen that individuals with moderate skill in telecommunications can implement the system as described above and pictured in FIG. 3.

Discussion of Invention and FIGS. 1, 2 and 3

This invention has been described in sufficient detail both with text and picture to allow an individual with a moderate telecommunications background to install the system. It is understood that this specific description has numerous variations and arrangements that would allow the same end result by simple modifying wire pair connections and pin-outs without materially changing the method described or departing from the scope of this invention.

Therefore, the full scope of this invention is defined in the appended claims and only one specific example is described in the descriptions and diagrams above.

I claim:

1. A method for Voice/Data communications over one 4 twisted pair communications wiring system installed in a star configuration, the method comprising:
A station module which provides access to 2 telephone lines or a business telephone station line in combination with an Ethernet data communications connection, a distribution module which combines the telephone lines or business telephone station lines from a business telephone system and the Ethernet connections from a network router or switch and delivers them through a 4 twisted pair communications wire to the station module that distributes the telephone lines and the Ethernet connections to the telephone station and a computer network card at various locations:

2. The method as recited above in claim 1, wherein business telephone system station lines and Ethernet connections are combined by a distribution module that delivers a business telephone extension and an Ethernet connection to a station location via 4 twisted pair communication wire and a station module which is pre-configure and provides access to a business telephone station line and an Ethernet data communications connection,
The Ethernet is transmitted through 2 spare pair in a 4 twisted pair communication wire that are not being used for a business telephone which requires 1 or 2 pair of a 4 pair communication wire.

3. The method recited above wherein the distribution module combines 2 telephone lines and an Ethernet connections onto multiple 4 pair communications cable and passes them through to stations with modules in such a way that telephone and Ethernet are available at the station outlets using only 4 twisted pair wire.

4. The method recited above wherein the station module with two RJ-45 female plugs on the face and 1 female RJ-45 or 110 punch down on the rear is pre-configured to deliver a business telephone station line and an Ethernet connection to a station location.

5. The method recited above wherein a station module with 3 RJ-45 female jacks and 1 male RJ-45 plugs into the station outlet and provides access to 2 telephone lines in jack 1, and 1 telephone line in jack 2 and Ethernet in jack 3; or a business telephone station in jack 1 and an Ethernet connection in jack 3.
